(19) United States
(12) Patent Application Publication
(10) Pub. No.: US 2025/0038293 A1
(43) Pub. Date: Jan. 30, 2025

(54) Battery Self-Warming Method

(71) Applicant: Comcast Cable Communications, LLC, Philadelphia, PA (US)

(72) Inventor: Joseph Thomas Rodolico, Nokomis, FL (US)

(21) Appl. No.: 18/360,456

(22) Filed: Jul. 27, 2023

(51) Int. Cl. H01M 10/615; H01M 10/44; H01M 10/63; H01M 10/657

(52) U.S. Cl. CPC H01M 10/615; H01M 10/443; H01M 10/63; H01M 10/657; H04N 7/186

(57) ABSTRACT

Systems, apparatuses, and methods are described for warming one or more batteries in a battery-operated device, such as a video doorbell. The battery's core may be internally heated by periodically forming a temporary short circuit between a positive electrode and a negative electrode of the battery. Such heating may warm the battery to a minimum operational temperature within seconds, so that the video doorbell is able to use its camera shortly after a motion is detected.

### BACKGROUND

Many battery-powered devices, such as doorbells and security cameras, are placed in outdoor environments and are exposed to temperature changes. Temperature extremes (e.g., low temperature, such as −30° Celsius) can degrade the performance of the batteries in these devices. For example, the batteries cannot supply power due to severely diminished capacity in the cold and cannot be recharged. This degradation, even though not permanent, may hinder the device's ability to perform its function, for example, to take a picture/video of a potential intruder, using the camera.

### SUMMARY

The following summary presents a simplified summary of certain features. The summary is not an extensive overview and is not intended to identify key or critical elements.

Systems, apparatuses, and methods are described for warming one or more batteries in a battery-operated device, such as a video doorbell. For example, the warming may be fast (e.g., within a few seconds). A power discharge circuit (or heating element) may be used to heat the battery's core directly and internally by forming a temporary (or pulsed) short circuit between a positive electrode and a negative electrode of the battery. Such short circuit may warm the battery significantly within seconds. Additionally, a variable power resistor may be connected between the positive electrode and the negative electrode. A computing device (e.g., a microprocessor) may be used to control the temporary short circuit so that a fuse connected to the battery does not activate and there is time to charge a capacitor (e.g., a supercapacitor) which supports a control circuit. For example, the short circuit may be formed periodically by connecting the positive electrode and the negative electrode for a period of time (e.g., 0.3 seconds) and disconnecting the positive electrode and the negative electrode for another period of time (e.g., 1 second). A temperature of the battery may be monitored by using a temperature sensor. The temperature sensor may be positioned directly on the negative electrode for direct battery temperature reading.

Heating of the battery may be triggered if the temperature of the battery is below a minimum operational threshold (or a first threshold) and if motion is detected. The video doorbell may turn on camera functions and take pictures/video, if the temperature of the battery is above (e.g., immediately above) the minimum operational threshold. In this way, for example, an approaching burglar may get his/her image captured within seconds even in cold weather (e.g., −30° C.). The battery may continue to be warmed by the power discharge circuit and/or another heat source (e.g., house power), and may be further warmed through fast or high-rate charging, if the temperature of the battery is above a minimum charging threshold (or a second threshold, e.g., 0° C.).

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 an example of a video doorbell.

FIG. 4A, FIG. 4B, FIG. 4C, and FIG. 4D show example circuits associated with heating one or more batteries.

FIG. 5 is a flow chart showing an example method for heating one or more batteries.

FIG. 6A is a flow chart showing an example method for operating a video doorbell in connection with heating one or more batteries; and FIG. 6B is another flow chart showing an example method for operating a video doorbell in connection with heating one or more batteries.

FIG. 7A and FIG. 7B show an example of a video doorbell functioning within seconds of detecting a burglar approaching a door.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

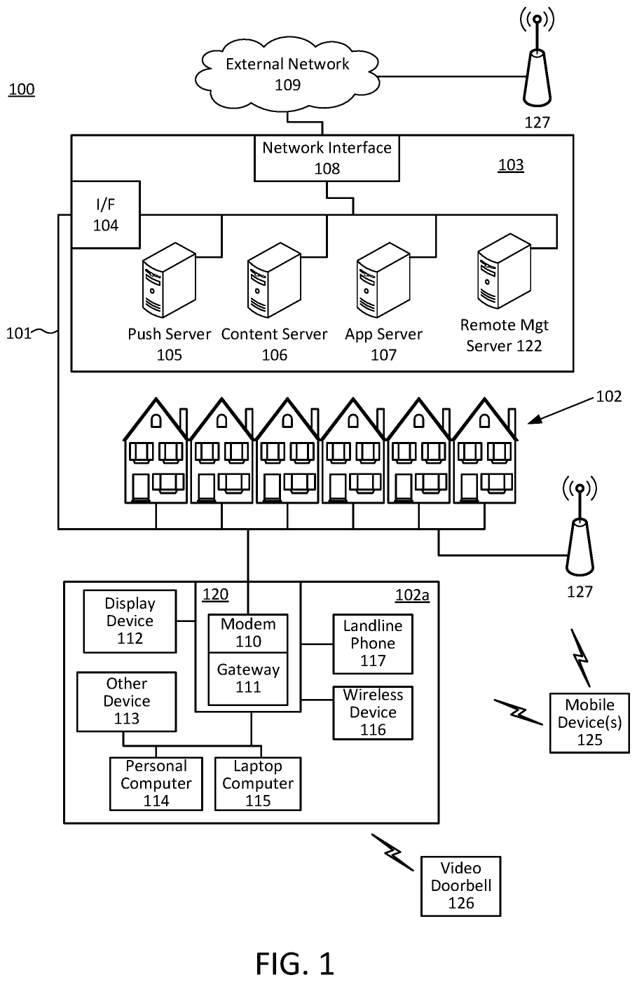

FIG. 1 shows an example communication network 100 in which features described herein may be implemented. For example, a video doorbell may be connected to the network and may send/receive data to/from a remote computing device (e.g., a server). The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the remote management (“Mgt”) server 122 (described below), additional push, content, and/or application servers, and/or other types of servers. The remote management server 122 may be configured to manage devices in the premises 102, for example, temperature-sensitive devices such as doorbells and one or more batteries associated with the doorbells. Although shown separately, the push server 105, the content server 106, the application server 107, the remote management server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises. A video doorbell 126, or other security device, may be installed for monitoring the premises 102a, and may communicate with remote management server 122 to, for example, provide uploads of security events captured by the video doorbell 126. The video doorbell 126 may be a wireless device 116.

The mobile devices 125, one or more of the devices in the premises 102a, and/or other devices may receive, store, output, and/or otherwise use assets. An asset may comprise a video, a game, one or more images, software, audio, text, webpage(s), and/or other content.

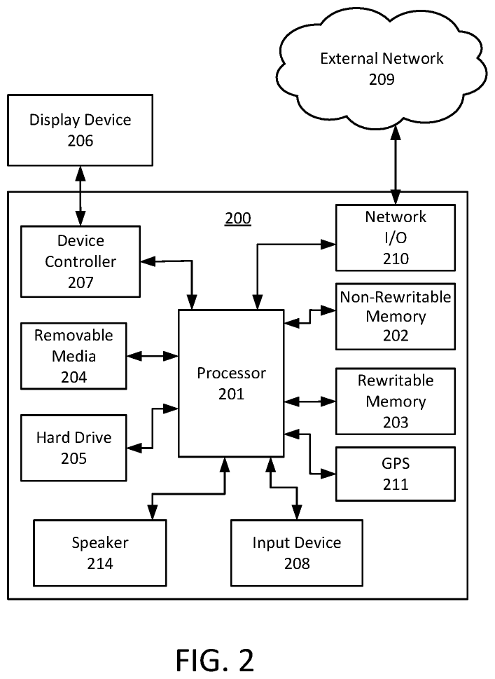

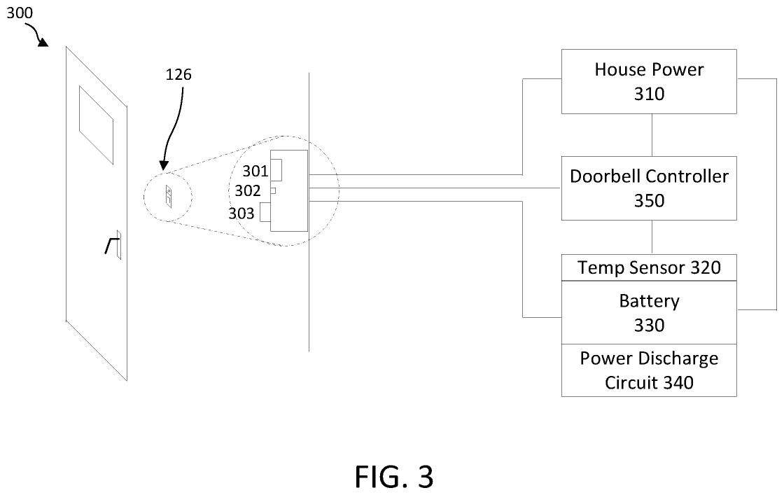

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., video doorbell 126). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more input devices 208 may comprise a remote control, a keyboard, a mouse, a touch screen (which may be integrated with the display device 206), microphone, sensor, etc. For example, the video doorbell 126 may comprise one or more motion sensors (e.g., motion sensor 302 in FIG. 3) to detect motions in a proximity of the doorbell. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

FIG. 3 shows an example of the video doorbell 126. The video doorbell 126 may be a smart device that combines a traditional doorbell with a camera function (e.g., taking still pictures and/or videos) and other functions such as motion sensing, facial recognition, internet connectivity, etc. For example, detection of movement near a door (e.g., door 300) may trigger a camera to start recording. A homeowner may be notified and may see and/or interact with visitors at the door 300 through a connected device such as a smartphone. Potential burglars or porch pirates may be deterred or recorded. The homeowner may also have knowledge of delivery personnel, friends, or family members who arrive at the door 300. The video doorbell 126 may transmit data including the captured image information to a remote computing device (e.g., the remote management server 122). The video doorbell 126 may have a user interface to present visual or audio information. For example, the video doorbell 126 may play advertisements during wait time of a visitor. The video doorbell 126 may be positioned anywhere relative to the door 300, for example, on a door rim, on a wall next to the door, on the door, etc. While a door 300 is used as an example, the video doorbell 126 may be used with any type of entry, such as garage door, window, etc.

The video doorbell 126 may comprise a camera (e.g., one or more image sensors) 301. The camera 301 may comprise one or more image sensing devices that comprise, for example, array of photosensitive elements (e.g., an array of charged-coupled device (CCD) and/or complementary metal oxide semiconductor (CMOS) elements), memory, and one or more processors and that may be configured to capture images using visible and/or invisible (e.g., infrared) light. Captured still and/or moving images (e.g., videos) may be sent by a doorbell controller (e.g., doorbell controller 350) to a remote destination, such as remote management server 122, via a data connection such as a wired or wireless network connection (e.g., wired connection 101, wireless connection via access points 127, etc.), which may in turn send the captured images to a homeowner's phone, to a security monitoring system, or any other desired destination. The camera 301 may also, or alternatively, comprise an ambient light sensor to detect an amount of light in the environment. The ambient light may be used, for example, to distinguish between day and night modes for image capture (e.g., night mode may use infrared image capture, while daytime modes may use visible light image capture). The camera 301 may also include one or more audio sensors (not shown) to capture sounds, and audio may be included with the video described herein. The camera 301 may comprise any other sensors if applicable.

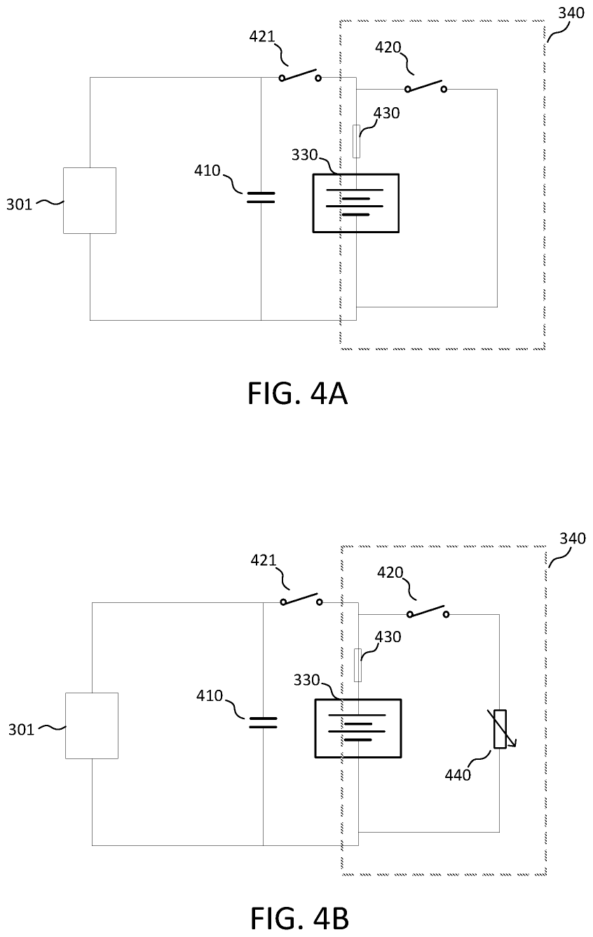

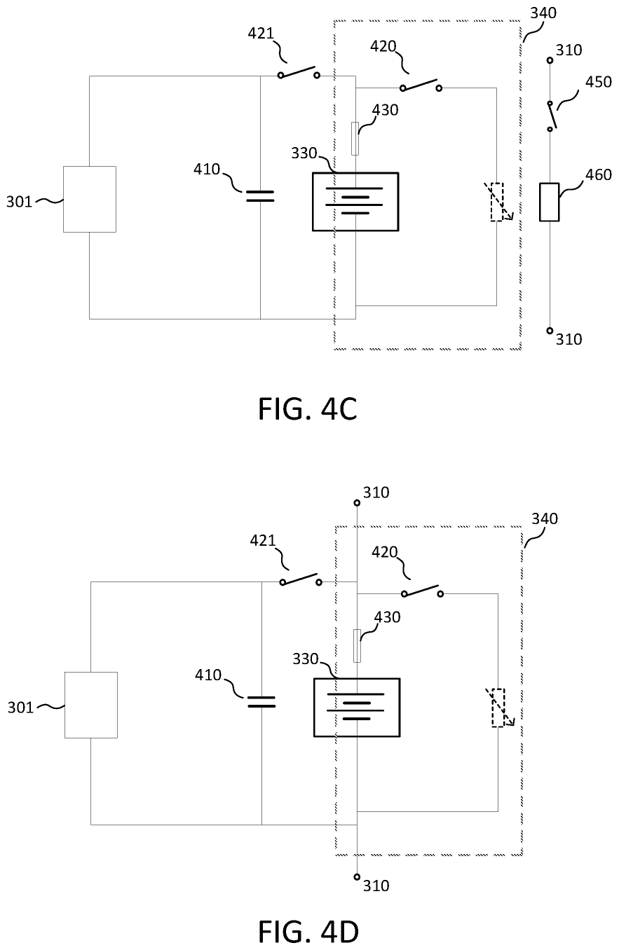

The video doorbell 126 may comprise one or more motion sensors 302 to detect motion in a proximity of the doorbell. The motion sensor 302 may comprise passive infrared (PIR) sensor or any other motion sensor that may apply (e.g., radar, etc.). Information indicating motion in the proximity of the doorbell may be sent to the doorbell controller 350 (e.g., one or more of device controller 207, processor 201, etc., in FIG. 2). The doorbell controller 350 may execute processes (e.g., stored in memory 202) based on the information. The doorbell controller 350 may further send the information to a remote destination (e.g., remote management server 122) for further use and/or processing. The motion sensor 302 may have varied detection ranges based on the type of motion sensor being used. For example, a PIR sensor may have a detection range of 20 to 50 feet (6 to 15 meters) or more. For example, radar may have a detection range of 10 to 50 meters or more. The motion sensor 302 may be a separate component of the video doorbell 126. Also or alternatively, the motion sensor 302 may be a built-in feature of the camera 301. The motion sensor 302 may be powered by house power 310 (e.g., 120V AC, 240V AC, etc.) and/or other power sources such as a capacitor (e.g., capacitor 410 in FIG. 4).

The video doorbell 126 may comprise a button 303 that a visitor is to press when wishing to announce their presence at the premises 102a. Pressing the button 303 may cause one or more house chimes (not shown) to make a sound such as a ringing bell. The house chimes may be traditional doorbell chimes in a house, and may be powered by the house's power network, such as AC power (e.g., house power 310). One or more speakers (e.g., speaker 214) may be used to connect to the chimes and play a sound based on the button 303 being pressed. Alternatively, the button 303 may be removed. The video doorbell 126 may activate the chimes based on other conditions, such as imaging action of the camera 301, detection of significant motion, remote control, etc. The chimes may serve various purposes other than notifying the presence of a visitor, for example, alerting the homeowner of significant activities near the door, intimidating potential intruders and/or animals, etc. Further functions may be triggered based on the activation of chimes, detection of motion, or other conditions. For example, security cameras inside and/or outside the premises 102a, not limiting to doorbell cameras, may be activated based on motion detected by the video doorbell 126.

The video doorbell 126 may further comprise one or more batteries (“battery”) 330 to provide electrical power for at least the camera 301. Using batteries to power the camera 301 may have advantages such as continuous operation even during power outages. The battery 330 may be rechargeable, and may receive power from the house power 310 via an AC-to-DC converter (not shown). The battery 330 may be non-rechargeable. The battery 330 may be cylindrical battery (e.g., 21700 battery, 18650 battery, etc.). The battery 330 may be pouch or flat battery (e.g., solid-state battery, square battery, etc.). The battery 330 may be any other battery that may apply to the video doorbell 126 to support the functions of its components (e.g., camera 301) and that may be negatively affected by cold weather operation. At least some battery chemistries may exhibit degraded performance if the battery is subjected to temperatures that are outside of a desired range. For example, the optimal operating temperature for a lithium-ion battery may be around 20° C. (e.g., between 15° and 35° Celsius). Such a battery cannot be recharged if the temperature drops below 0° C., and may cease to operate altogether if the temperature reaches −20° C. This may lead to compromised security as the battery-powered camera 301 cannot operate at a low temperature and images cannot be taken when needed (e.g., for a potential intruder). The battery 330 and/or its related circuit/component may be located inside the video doorbell 126. Alternatively, the battery 330 and/or its related circuit/component may be located at least partially outside the video doorbell 126.

The video doorbell 126 may comprise one or more temperature (“temp”) sensors 320 to detect the temperature of the battery 330. The temperature sensor 320 may be positioned directly on the battery 330, for example, on a metal surface of a negative electrode of the battery 330 (e.g., cylindrical battery). If the battery 330 is a pouch battery with integrated temperature sensors, the temperature sensor 320 may be an internal temperature sensor that is already in the pouch battery. Alternatively, the temperature sensor 320 may be an external temperature sensor located on a pouch battery. By placing the temperature sensor directly on the electrode or using the internal temperature sensor, direct battery temperature reading may be realized. Such reading may be more accurate than that obtained based on temperature sensors adjacent to the battery 330 (e.g., on a small circuit board above or next to the battery) which actually reads ambient battery temperature, although such adjacent temperature sensors may also, or alternatively, be used. The temperature sensor 320 may be powered by the battery 330, the house power 310, and/or other power sources such as a capacitor (e.g., capacitor 410).

The video doorbell 126 may comprise a power discharge circuit (or heating element) 340 to warm the one or more batteries 330. For example, the warming may be quick (e.g., within a few seconds). Capacity of a battery at least partially returns, for example, if the battery temperature is raised to a certain level (e.g., above −20° C., at 0° C., etc.). The house power 310 may be used to heat the batteries, cameras, etc. For example, the house power 310 (e.g., 2 Watts) may power an external heat generator (e.g., second heat source 460 in FIG. 4C) such as a power transistor, power resistor, heater coil element, etc. The external heat generator may be positioned on or adjacent to an object to be warmed. For example, a power resistor may take the form of a flexible pad which wraps around the object (e.g., camera, battery) to transfer the heat. For a battery (e.g., battery 330), the external heat generator may continually operate to keep the temperature of the battery 330 above a critical threshold (e.g., −40° C. or other temperature). At or below the critical threshold, the battery 330 may be damaged and/or too frozen to be revived by even extreme heat. The external heat generator may be used to raise/keep the temperature of the battery 330 to/at an operational temperature (any temperature or temperature range for the battery 330 to have enough capacity/voltage to support a desired function; e.g., above −20° C.). However, this may consume lots of energy, and it may be difficult to increase the temperature significantly (e.g., to 0° C.) due to limitations on house power. Energy may be saved if the battery 330 is warmed to an operational temperature (e.g., above −20° C.) based on motion being detected near the door 300, so that the camera function may be turned on. But external heating takes time to raise the temperature of an object, especially if a limited power source such as the house power 310 is used. For example, it may take minutes to increase the temperature of the battery 330 to above −20° C., which means that it may take minutes after motion is detected before a battery-powered camera can function (e.g., take pictures or record a video). That leaves minutes' long no-camera time and renders the video doorbell almost useless in most situations.

The power discharge circuit 340 may generate heat inside the battery 330 to heat the battery 330, and may increase the temperature of the battery 330 significantly within a few seconds. If the battery 330 is short-circuited, then internal resistance of the battery will produce heat as the battery discharges due to the short circuit. For example, a lithium-ion battery may include a small amount of internal resistance, and this internal resistance may produce heat based on the current that the battery provides. If the battery is short-circuited, then this current becomes very large, and the current flowing through that internal resistance will produce heat. Also, the ion/electron transfer (the chemical reaction) in discharging a lithium-ion battery will also produce heat from the chemical reaction. A short circuit may stress the battery, but if the short circuit is only maintained for a very brief duration, the damage to the battery may be minimized, while some heat may be quickly produced. The power discharge circuit 340 may form a short circuit with or without load and may discharge the battery 330 using the short circuit to generate heat. The power discharge circuit 340 may be used alone or in combination with external heat sources (e.g., heat generated by using the house power 310). The power discharge circuit 340 may also generate heat outside the battery 330 (e.g., if there is load, and the load may generate heat due to its resistance), and the external heat may be used to warm the battery 330 as well. The operation of the power discharge circuit 340 may be controlled by the doorbell controller 350 which may be powered by the house power 310 and/or other power sources such as a capacitor (e.g., capacitor 410).

The video doorbell 126 may comprise various other components or elements not shown herein for clarity purpose (e.g., to avoid cluttering in FIG. 3). For example, the video doorbell 126 may comprise image and/or audio processing hardware and/or software, to allow the video doorbell 126 to process images and/or audio for various purposes. The video doorbell 126 may comprise one or more lighting elements such as light-emitting diodes, to provide illumination of the surrounding area. The lighting elements may help to improve the video quality of images captured by the camera 301. The lighting elements may provide visible light and/or infrared light, to complement the image-capturing abilities of the camera 301. The video doorbell 126 may further comprise capacitor, transformer, converter, relay, compensation, etc. These circuit components may help the video doorbell 126 to work smoothly with, for example, the house power 310, to realize its functions. Though shown in FIG. 3, house power 310 may be omitted, and the video doorbell 126 may operate without using house power 310.

FIG. 4A, FIG. 4B, FIG. 4C, and FIG. 4D (collectively “FIG. 4”) show example circuits associated with heating one or more batteries. FIG. 4A and FIG. 4B show examples of a power discharge circuit 340 for fast warming one or more batteries 330. FIG. 4C additionally shows a heat source 460 powered by, for example, the house power 310. FIG. 4D additionally shows a charging circuit for the house power 310 to recharge the one or more batteries 330. For example, the battery 330 may be recharged at a high rate so that the battery 330 may be further warmed up. This will be described below in detail with respect to FIG. 4D.

In FIG. 4, the battery 330 may be used to supply electricity to the camera 301 and/or other devices. A capacitor 410 may be connected to the battery 330 to serve as a temporary energy storage device and to smooth out voltage fluctuations and transient currents. The capacitor 410 may comprise one or more capacitors. The capacitor 410 may comprise a supercapacitor or a bulk capacitor. The capacitor 410 may be charged and discharged rapidly, can handle high currents (e.g., currents caused by a short circuit), and may have a relatively large capacitance value (e.g., a few to tens of Farads). The capacitor 410 may be used to supply electricity to a control circuit that may include the doorbell controller 350, for example, if the battery 330 is not functioning and/or if the house power 310 is not available. The battery 330 may be further connected with a fuse 430. A fuse may be a thin strip or wire made of a material that has a low melting point (e.g., copper, tin, etc.). A fuse may protect the circuit and/or connected devices by activating (e.g., opening up, e.g., due to excessive heat) when the current exceeds a predetermined level. The fuse 430 may be a slow blow fuse and/or a resettable fuse such as a positive temperature coefficient (PTC) fuse. Both the slow blow fuse and the PTC fuse have a time delay to operate at an overcurrent before opening up. The fuse 430 may comprise a temperature sensor to monitor its temperature. The fuse 430 may be located close to the battery 330. The fuse 430 may even be inside (e.g., embedded in) the battery 330. For example, a 21700 battery or a 18650 battery may have a PTC fuse embedded in the battery's top. The power discharge circuit 340 may comprise a switch 420 that is operable between ON and OFF positions to enable and disable the power discharge circuit. The power discharge circuit 340 may be normally OFF. A switch 421 may be provided between the capacitor 410 and the battery 330 to enable/disable electric connection between the capacitor 410 and the battery 330. The operations of the switch 420 and the switch 421 may be automatically controlled by the doorbell controller 350. For example, the switch 420 and the switch 421 may be controlled to take opposite ON or OFF positions. The Table 1 below shows an example of the relationship between the switches 420 and 421 as well as momentary short circuit by the power discharge circuit 340.

TABLE 1

| Momentary Short | | |
|---|---|---|
| Circuit | Switch 420 | Switch 421 |
| Disabled | OFF (open) | ON (closed) |
| Enabled | ON (closed) | OFF (open) |

When the power discharge circuit 340 is operating, the switch 420 and the switch 421 may be automatically controlled to change ON/OFF positions in a high frequency. For example, the switch 420 may be ON for a period of time (e.g., 0.3 seconds), while the switch 421 is OFF during the same period of time. In this short period, the power discharge circuit 340 is enabled, and the capacitor 410 is not connected to or charged by the battery 330. Then the switch 420 may be OFF for a period of time (e.g., 1 second), and the switch 421 is ON during the same period of time. In this short period, the power discharge circuit 340 is disabled, and the capacitor 410 is connected to or charged by the battery 330. More details will be described below with respect to individual figures of FIG. 4.

In FIG. 4A, the power discharge circuit 340 may form a momentary short circuit that directly connects a positive electrode and a negative electrode of the battery 330. The short circuit when formed may generate a surge in electrical current which may lead to significant amount of heat generated inside the battery 330. A surge current may activate the fuse 430 in a short time, for example, 0.5 seconds. To prevent the fuse 430 from activating, the short circuit may need to apply for a limited time, for example, 0.3 seconds, then be disabled (e.g., by opening switch 420), so that the fuse 430 does not activate, and to allow the fuse 430 to cool. During the disabled or OFF period (e.g., 1 second) of the short circuit, the capacitor 410 may be charged by the battery 330 (e.g., with a closed switch 421). When the battery 330 is connected to the momentary short circuit, the battery's voltage may drop dramatically (e.g., to near zero), thus the battery 330 may not be able to support any functional component (or circuit) such as the doorbell controller 350 during that time. A charged capacitor 410 may provide electricity to the doorbell controller 350 and/or other components, for example, if other power sources such as the house power 310 is not available. A boost circuit (not shown) may be used to boost a voltage of the capacitor 410 during the ON period of the short circuit (e.g., when the switch 421 is open). The durations of the enabled (ON) and disabled (OFF) periods of the short circuit may depend on the type/size of battery, material of the fuse, etc., and may be determined based on common knowledge in the art and/or through limited number of experiments. By periodically forming a momentary or temporary short circuit (“pulsed short circuit”) as described above, the battery 330 may be significantly warmed up in a short time, for example, a few seconds.

In FIG. 4B, the power discharge circuit 340 may comprise a variable power resistor 440 connected between the positive electrode and the negative electrode of the battery 330. The variable power resistor 440 may change its resistance value to control the flow of current in the power discharge circuit 340. For example, the variable power resistor 440 may be adjustable from 0.1 Amps to 15 Amps depending on the battery 330 to accomplish battery warming. Due to the resistance in the variable power resistor 440, the variable power resistor 440 may generate external heat in addition to the heat generated inside the battery 330. The external heat may be also used to warm up the battery 330. For example, the variable power resistor 440 may be mounted to the battery body to enhance battery warming. A temporary short-circuit may cause the battery to generate heat from within-such as due to its internal resistance-which may allow for quicker warming of the battery. With the variable power resistor 440, when the resistance is adjusted, the amount of electric current that will flow through terminals of the battery 330 changes. The current will produce heat in the battery 330. For example, the resistance may be lowered such that a short circuit is formed, and that would provide maximum current and maximum heat. Such a short circuit would be very momentary, to avoid activating a fuse or seriously damaging the battery. A wide range of electric current may be provided to apply to different situations involving battery type, battery size, battery temperature, time, etc. For example, the variable power resistor 440 may be adjusted to have minimum resistance when the battery temperature is below a minimum operational threshold of a battery 330, so that the battery 330 may be heated up quickly by a maximum current. After the battery temperature is raised to above a minimum operational threshold, as the urgency has reduced (e.g., the camera 301 can function), a milder circuit may be formed by increasing the resistance of the variable power resistor 440. A milder way of heating may reduce any possible negative effect on the battery 330 by intense short circuiting. The variable power resistor 440 may be replaced by a fixed power resistor or a power transistor.

In FIG. 4C, in addition to the power discharge circuit 340, there may optionally be a second heat source 460 for the battery 330. The second heat source 460 may be connected to and powered by the house power 310. The second heat source 460 may be an external heat generator such as power resistor, power transistor, heater coil, etc. The second heat source 460 may be positioned adjacent to or on the battery 330 to transfer heat for warming the battery 330. The second heat source 460 may be used with insulation to enhance the heating effect. An operation of the second heat source 460 may be switched ON and OFF by using a switch 450. The switch 450 may be controlled by the doorbell controller 350. As described above, an external heat generator powered by the house power 310 cannot warm up a battery within seconds. Thus, the second heat source 460 is not the primary heat source for warming up the battery 330 from a low temperature (e.g., −25° C.) to above a minimum operational threshold (e.g., −20° C.), in the example of the video doorbell 126. After the power discharge circuit 340 increases the temperature of the battery 330 to above the minimum operational threshold, the power discharge circuit 340 may be turned OFF, and the second heat source 460 may be turned ON to continue warming the battery 330 to a higher temperature. Alternatively, the power discharge circuit 340 may continue to be ON after the temperature exceeds the minimum operational threshold, especially if the desired function is energy consuming. The battery 330 may need to be recharged soon, thus it may be relatively urgent to increase the battery temperature to a charging temperature (e.g., 0° C. or above, where the battery 330 is rechargeable). The second heat source 460 may serve as an optional or supplemental heat source to the power discharge circuit 340. The second heat source 460 may be kept ON. The second heat source 460 may reduce the burden of the power discharge circuit 340 to increase the battery temperature, and may help to limit any negative effect caused by short circuiting to the minimum. In situations where there is no house power for the video doorbell 126, the second heat source 460 may be eliminated.

In FIG. 4D, in addition to the power discharge circuit 340, there may optionally be a charging circuit for the house power 310 to recharge the one or more batteries 330. The charging circuit may be normally ON for keeping the battery 330 recharged. Alternatively, the charging circuit may comprise a switch (not shown) that may be controlled by the doorbell controller 350. If the temperature of the battery 330 is below a minimum charging threshold (“charging threshold”, e.g., 0° C.), the battery 330 cannot be recharged, even when the charging circuit is ON. After the temperature of the battery 330 reaches the minimum charging threshold, the charging circuit may charge the battery 330 with a high rate (“fast charging”) to generate heat for further warming up the battery 330. A charging rate may be considered a high charging rate, if a charging current exceeds 1-2 times the battery's capacity (C-rate). For example, for a battery with a capacity of 3 Ampere-hours, charging the battery at a rate above 3 A to 6 A may be considered a high rate. Charging or recharging a battery at a high rate may lead to increased heat generation, which may cause overheating etc. and thus is usually not recommended. In a situation where a battery needs to be quickly warmed up for higher power output in a cold environment, fast charging may be an effective way to help raise the battery temperature. Similar to short circuiting as mentioned above, fast charging as described herein is also temporary and for a short time (within seconds, no more than a few minutes), and thus may not cause significant or permanent damage to the battery.

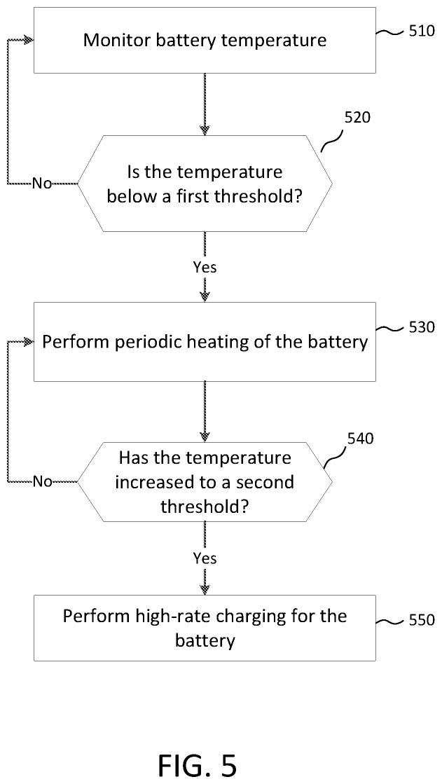

FIG. 5 is a flow chart showing an example method for heating one or more batteries. The method may be performed by any device that controls (directly or indirectly) one or more of the circuits associated with heating the one or more batteries. The circuits may comprise the power discharge circuit 340, the circuit with the second heat source 460, and the charging circuit as described above. For example, the method may be performed by the doorbell controller 350, the remote management server 122, the interface 120, the gateway 111, a personal computer 114, or any other desired device or combination of devices. One or more steps of the example method of FIG. 5 may be rearranged (e.g., performed in a different order), omitted, and/or otherwise modified, and/or other steps added. For example, a step for determining if a battery has a low capacity may be added.

In step 510, temperature of a battery (e.g., battery 330) may be monitored. For example, information indicating the temperature of the battery 330 may be received from the temperature sensor 320. As described above, the temperature sensor 320 may be positioned directly on or inside the battery 330, so that the battery temperature rather than an ambient temperature may be detected. The temperature sensor 320 may be connected to and communicate with a control circuit, for example, the doorbell controller 350, via wire or wirelessly. The battery temperature to be monitored may comprise a temperature range depending on the battery 330. For example, for a typical Li ion battery, the temperature range may be from −35° C. to 60° C. Alternatively, the temperature range may have no limit or only be limited by the capability of the temperature sensor 320. Although not explicitly shown in FIG. 5, monitoring battery temperature may be constant and may apply to every step in FIG. 5.

In step 520, a determination may be made as to whether the temperature of the battery 330 is below a first threshold (e.g., minimum operational threshold). The first threshold may be a temperature at or above which the battery 330 functions. A voltage and capacity of the battery 330 will diminish as the battery temperature decreases. Table 2 below shows example temperature versus voltage/capacity for a camera battery. For example, a fully charged battery 330 may only have 5% of capacity at the temperature of −30° C., which may not be enough to support the functions of a camera (e.g., camera 301). At the temperature of −20° C., the battery 330 may have increased its capacity to 10%, which may start to support some functions. The first threshold may be determined based on the battery type, size, percentage of charge, and needed capacity of a desired function, etc. and may be programmed into a controller such as the doorbell controller 350. The first threshold or minimum operational threshold may vary greatly among different desired functions. For example, for the example battery in Table 2, −20° C. may be a minimum operational threshold for simple functions such as sensor function, while a more complex function such as camera function may need a higher minimum operational threshold. If there are more than one desired functions which require different minimum operational thresholds, a lower minimum operational threshold may be selected as the first threshold. If no function is specified, the first threshold may be a minimum temperature for normal operation of the battery 330. Optionally, a determination may be further made as to whether the temperature of the battery 330 is above a critical threshold (e.g., −40° C. or other temperature). The critical threshold may be a temperature at or below which the battery 330 may be too damaged or frozen to be revived even with short circuit. The critical threshold may be determined based on the battery type, size, etc., and may be programmed into a controller such as the doorbell controller 350.

TABLE 2

| Camera Battery | Battery Voltage\Capacity |
|---|---|
| Temperature (° C.) | (fully charged battery) |
| −35 | 2.4 v\2% |
| −30 | 2.5 v\5% |
| −20 | 3.0 v\10% |
| −10 | 3.5 v\20% |
| 0 c. | 3.7 v\30% |
| 10 | 3.9 v\40% |
| 20 | 4.1 v\80% |
| 30 | 4.1 v\82% |
| 40 | 4.1 v\83% |
| 50 | 4.1 v\84% |
| 60 | 4.1 v\85% |

In Table 2, the battery voltage/capacity at each temperature is based on a fully charged battery. If the battery is not fully charged, for example, is half charged, the voltage/capacity at each temperature may be reduced by half. For example, at −20° C., to send a signal to ring a doorbell chime (20% capacity needed), it may need to warm the battery to −10° C. for a fully charged battery. If the battery is half charged, it may need to warm the battery to 10° C.

If the temperature of the battery 330 is below the first threshold, then in step 530, periodic heating of the battery 330 may be performed by using a short circuit (e.g., a pulsed short circuit). For example, the power discharge circuit 340 as shown in FIG. 4A may be turned ON and OFF periodically. The durations of the ON and OFF periods of the short circuit may depend on the type/size of battery, material of the fuse, etc. For example, for a 21700 battery, the short circuit may be ON for 0.3 seconds and OFF for 1 second, repeating the cycle. The periodic heating by short circuit may generate surge current which leads to significant heat in the battery 330. The heat warms the battery 330 significantly to increase the temperature of the battery 330, and the brief surge current lasts short enough to not activate the fuse 430. During intervals (OFF periods) of the short circuit, the fuse 430 (e.g., a PTC fuse) may cool down, and a capacitor (e.g. supercapacitor) 410 may be charged by the battery 330. The capacitor 410 may be used to provide electricity to devices such as the doorbell controller 350, for example, if other power sources (e.g., the house power 310) are not available. By performing the short circuit cycle, the battery 330 may increase its temperature significantly within seconds. Table 3 below shows a comparison between time needed to increase a certain amount of temperature by using such momentary short circuit and that by using an external heater.

TABLE 3

| Camera Battery | Battery | | | | |
|---|---|---|---|---|---|
| Temperature | Voltage\Capacity | Momentary | | External | |
| (° C.) | (fully charged battery) | Short Circuit | | Heater | |
| −35 | 2.4 v\2% | 2 | seconds | 15 | minutes |
| −30 | 2.5 v\5% | | | | |
| −20 | 3.0 v\10% | 2 | seconds | 15 | minutes |
| −10 | 3.5 v\20% | | | | |
| 0 c. | 3.7 v\30% | 1 | second | 10 | minutes |
| 10 | 3.9 v\40% | | | | |
| 20 | 4.1 v\80% | 1 | second | 5 | minutes |
| 30 | 4.1 v\82% | | | | |
| 40 | 4.1 v\83% | 0.5 | second | 5 | minutes |

| | | | |
|---|---|---|---|
| 50 | 4.1 v\84% | | |
| 60 | 4.1 v\85% | \ | \ |

In Table 3, the column “Momentary Short Circuit” lists time needed for each temperature increase for an example battery. A comparison is also provided by the column “External Heater”. For example, it may use 2 seconds to increase the battery temperature from −35° C. to −30° C. using the momentary short circuit. In comparison, if using an external heater (e.g., by house power 310) to heat the battery, it may take 15 minutes. As the battery temperature increases, it may take less time for the momentary short circuit to achieve the temperature rise. For example, it may take 1 second to increase the battery temperature from 0° C. to 10° C. using the momentary short circuit. The numbers in Table 3 are only examples and are shown to demonstrate the momentary short circuit method. These numbers are by no means limitative.

As shown in the example Table 2 and Table 3, the battery voltage and capacity increase along with an increased temperature. Increased voltage and capacity may enable the battery 330 to perform desired functions for devices (e.g. camera 301) that it supports.

Though not shown, step 530 may be performed together with a second heat source (e.g., second heat source 460) if applicable. The second heat source 460 may serve as a supplemental heat source. If the battery temperature exceeds the first threshold, the second heat source 460 may optionally be a main heat source (e.g., the power discharge circuit 340 may be optionally turned OFF in some situations).

Alternatively, if the temperature of the battery 330 is not below (e.g., at or above) the first threshold, or if the temperature of the battery 330 is not above the critical threshold, then in step 510, the battery temperature continues to be monitored. The periodic short circuit heating as described with respect to step 530 is not performed, as the battery 330 may be considered to either have enough capacity to support desired functions or be so damaged that it is not functional. As mentioned above, the house power 310, if available, may help with keeping the battery temperature above the critical threshold.

In step 540, a determination may be made as to whether the temperature of the battery 330 has increased to a second threshold. The second threshold may be a minimum charging threshold (or “charging threshold”) at or above which the battery 330 is rechargeable. For example, the second threshold may be 0° C. The second threshold may be determined based on battery properties, etc. and may be programmed into a controller such as the doorbell controller 350.

If the temperature of the battery 330 has not reached the second threshold, then in step 530, battery heating may be continued to increase the battery temperature. A higher battery temperature may release more capacity/voltage from the battery 330, and in some situations, the battery 330 may need to be recharged in order to support certain desired functions continuously.

If the temperature of the battery 330 has reached the second threshold, then in step 550, high-rate charging for the battery 330 may be performed. As described above, high-rate charging may generate excessive heat in the battery 330 and is usually not recommended. However, the heat may be used to further boost the temperature of the battery 330. When the battery 330 is rechargeable (e.g., at or above the second threshold), the battery 330 may be recharged to add power and to be warmed further if the recharging is at a high rate. Alternatively, a normal-rate charging may be performed. The battery 330 may be further warmed by using the power discharge circuit 340 (e.g., the highly efficient pulsed short circuit) and/or the second heat source 460. Alternatively, the power discharge circuit 340 and/or the second heat source 460 may be turned off. In a situation where recharging the battery is not possible (e.g., no house power, non-rechargeable battery, etc.), step 540 and/or step 550 may be removed. The heating in step 530 may be ceased, if either the first threshold or the second threshold or any other desired temperature threshold is reached.

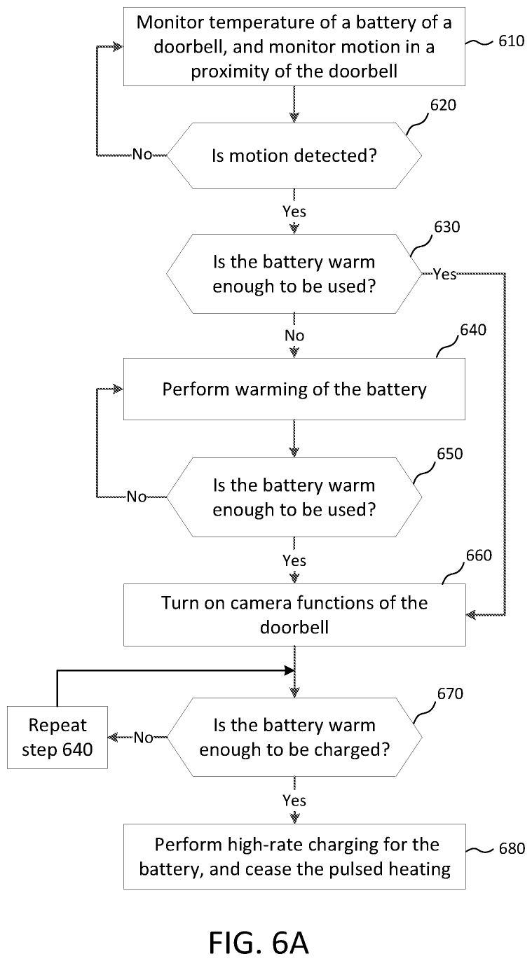

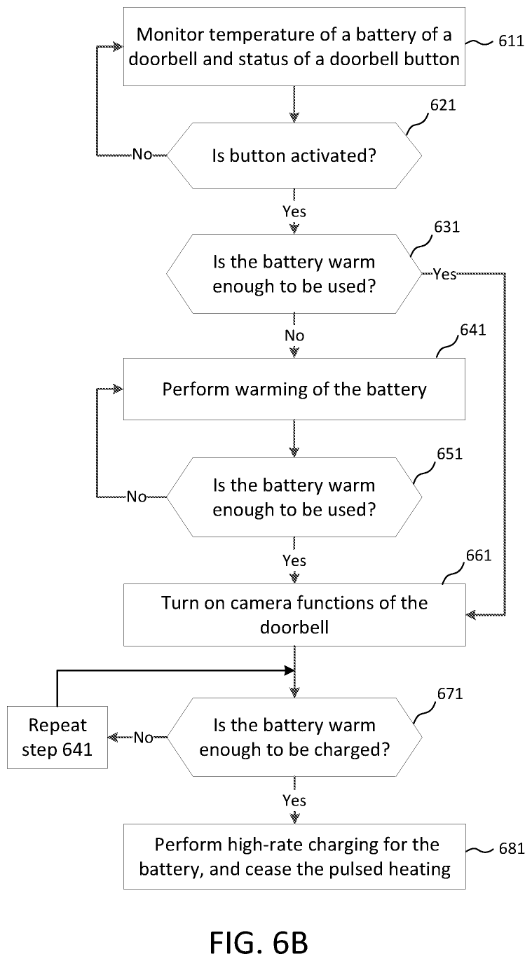

FIG. 6A is a flow chart showing an example method for operating a video doorbell in connection with heating one or more batteries. The method may be performed by any device that controls (directly or indirectly) one or more of the circuits associated with heating the one or more batteries. The circuits may comprise the power discharge circuit 340, the circuit with the second heat source 460, and the charging circuit as described above. For example, the method may be performed by the doorbell controller 350, the remote management server 122, the interface 120, the gateway 111, a personal computer 114, or any other desired device or combination of devices. One or more steps of the example method of FIG. 5 may be rearranged (e.g., performed in a different order), omitted, and/or otherwise modified, and/or other steps added. For example, a step for determining if a battery has a low capacity may be added.

In step 610, a temperature of a battery (e.g., battery 330) of a doorbell (e.g., video doorbell 126) may be monitored, and motion in a proximity of the doorbell may be monitored. For example, information indicating the temperature of the battery 330 of the video doorbell 126 may be received from the temperature sensor 320. Information indicating motion in the proximity of the video doorbell 126 may be received from the motion sensor 302. Although not explicitly shown in FIG. 6A, the monitoring of the temperature and motion may be continuous and may apply to each step in FIG. 6A.

In step 620, a determination may be made as to whether motion is detected in the proximity of the doorbell. For example, PIR sensors may detect changes in infrared radiation emitted by objects in their field of view. When a person or object moves within the sensor's detection range, it causes a change in the infrared energy pattern. When the PIR sensors detect a rapid change in the infrared pattern, a motion detection may be triggered.

If motion is detected in the proximity of the doorbell, then in step 630, a further determination may be made as to whether the battery 330 is warm enough to be used. Alternatively, if motion is not detected in the proximity of the doorbell, then in step 610, the monitoring of the temperature and motion may continue.

In step 630, a determination may be made as to whether the battery 330 is warm enough to be used. For example, if the temperature of the battery 330 is above a first threshold (e.g., the first threshold as mentioned in step 520 in FIG. 5), the battery 330 may be considered as warm enough to be used. For example, in the example Table 2, a fully charged battery has 20% capacity at −10° C., and may be considered warm enough to be used for a house chime, as the house chime may need the 20% capacity to operate. The first threshold may be determined based on the battery and the needed capacity of a desired function, and may be programmed into a controller such as the doorbell controller 350. For example, if the desired function is camera functions of the video doorbell 126, and if the camera functions need 30% capacity of a fully charged 21700 battery, then the first threshold may be determined as a temperature where the fully charged 21700 battery has 30% capacity, for example, −20° C.

If the battery 330 is warm enough to be used (e.g., battery temperature exceeding the first threshold), then in step 660, functions of a camera (e.g., camera 301) of the doorbell (e.g., video doorbell 126) may be turned on. Camera functions may comprise taking pictures, recording a video, etc. As described above, camera functions may be turned on based on detection of motion. Since motion is detected, the camera may capture images of the person, animal, or other object causing the motion.

Alternatively, if the battery 330 is not warm enough to be used, then in step 640, warming of the battery 330 may be performed. For example, pulsed heating (e.g., by using pulsed short circuit) of the battery 330 by a power discharge circuit 340 may be performed. Details of such heating have been described above (e.g., with respect to step 530) and will not be repeated herein. In the example of FIG. 6A, warming of the battery 330 does not happen, for example, the power discharge circuit 340 is not used (e.g., momentary short circuit is not used), if no motion is detected. This may save energy and protect the life of the battery. Warming of the battery 330 may be fast. For example, the power discharge circuit 340 may generate heat in the battery 330 and increase the temperature of the battery 330 significantly within seconds. Other battery warming methods such as using the second heat source 460 may be used to add further heat to the battery 330. The temperature sensor 320 monitors the battery temperature as the warming is performed.

In step 650, a determination may be made as to whether the battery 330 is warm enough to be used. If the temperature of the battery 330 is above the first threshold, the battery 330 may be considered as warm enough to be used; then in step 660, functions of the doorbell such as camera functions may be turned on. Alternatively, if the battery 330 is not warm enough to be used, the heating of the battery 330 may continue in step 640.

In step 670, a determination may be made as to whether the battery 330 is warm enough to be charged. For example, if the temperature of the battery 330 is above a second threshold (e.g., the second threshold as mentioned in step 540 in FIG. 5), the battery 330 may be considered as warm enough to be charged. At least some desired functions (e.g., taking pictures/videos by the camera 301) may consume a considerable amount of power. In order to continuously support the desired functions, the battery 330 may need to be recharged, if needed and if available. In situations where house power is not available and/or the battery 330 has a larger capacity (e.g., the 21700 batteries), it may still be beneficial to increase the battery temperature to a higher level to release more capacity.

If the battery 330 is warm enough to be charged, then in step 680, high-rate charging for the battery 330 may be performed, similar to step 550 in FIG. 5. Also, the pulsed heating as mentioned in step 640 may be ceased. Alternatively, the pulsed heating may be continued. If the battery 330 is not warm enough to be charged, then the warming of the battery 330 as in step 640 may be continued. In situations where charging the battery is not possible or desired, the step 670 and step 680 may be removed. In those situations, the warming of the battery may cease or continue after step 660, depending on power requirement for the functions in step 660 and the battery, etc.

FIG. 6B is another flow chart showing an example method for operating a video doorbell in connection with heating one or more batteries. FIG. 6B is different from FIG. 6A in step 611 and step 621. Steps 631, 641, 651, 661, 671, and 681 are similar as the steps 630, 640, 650, 660, 670, and 680 in FIG. 6A, and will not be described in detail below.

In FIG. 6A, motion detection is used to trigger the battery warming determination and subsequent steps. In FIG. 6B, a doorbell button (e.g., button 303) may be monitored (in step 611) and determined for its status (in step 621). For example, if the button 303 is determined to be activated (e.g., pressed), in step 631, a determination may be made as to whether the battery (e.g., doorbell battery 330) is warm enough to be used. The functions of the doorbell (e.g., video doorbell 126) such as camera functions may be turned on immediately or after warming up the battery 330, depending on the determination result in step 631. As the warming up of the battery 330 may be fast (e.g., within a few seconds), the camera functions may be able to function in time after the button 303 is activated. Alternatively, if the button 303 is determined to be not activated, the video doorbell 126 may continue the monitoring without turning on the camera functions or warming the battery 330.

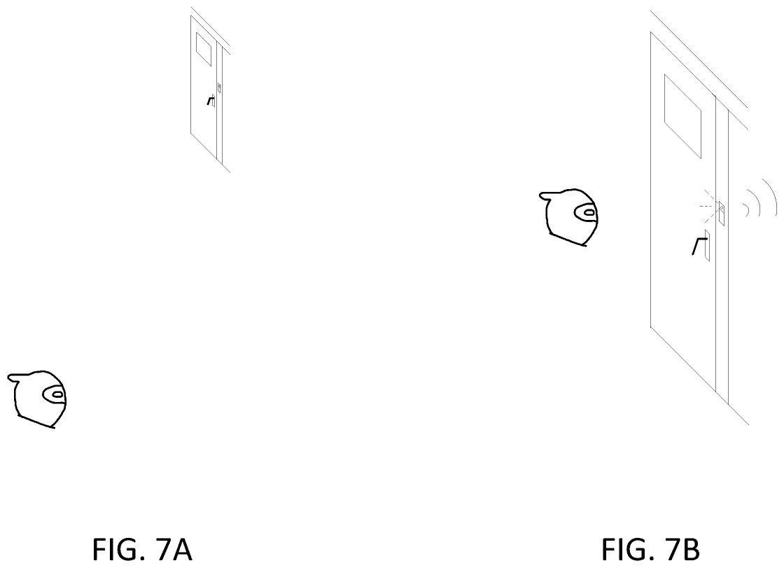

FIG. 7A and FIG. 7B show an example of a video doorbell functioning within seconds of detecting a burglar approaching a door. In FIG. 7A, a potential intruder (e.g., a burglar) may approach a door (e.g., door 300) of a premise from a distance of, for example, 50 feet (15 meters). A motion detector (e.g., the motion sensor 302) of the video doorbell (e.g., video doorbell 126) may detect the motion. If the weather is cold, the detection of the motion may trigger a warming process of a battery (e.g., doorbell battery 330) as describe above. On average, a person walking at a moderate pace might cover a distance of around 3 to 4 feet per second. Thus, it might take approximately 12 to 17 seconds for the burglar to reach the door (e.g., as shown in FIG. 7B) from 50 feet away. Even if the burglar moves faster, it may still take a few seconds. And by the time the burglar is at the door, the battery 330 may have already been warmed up to the extent that a doorbell camera (e.g., camera 301) is functioning. FIG. 7B shows that the doorbell snaps a picture or records a video of the burglar. In addition, FIG. 7B shows an alert (e.g., a chime) that may be triggered, for example, based on the functioning camera. The chime may notify the owner inside the premise or with a connected smartphone, and/or may intimidate a potential intruder or porch pirate. Alternatively, the alert may happen earlier than the turning on of camera. The chime may be powered by the battery 330 or the house power 310. The burglar in FIG. 7A and FIG. 7B is a symbolized example. It may be any object that triggers the motion detection.

The battery or batteries as mentioned in this specification may have applications other than doorbells, as long as those applications need fast warming of the battery in a cold environment. For example, the battery and its heating circuits may be used in the outer space (e.g., spacecraft, etc.), transportation (e.g., electric vehicles, etc.), the refrigeration industry, winter/high-elevation sports, etc., and may be quickly warmed using its own power (or self-warmed) to perform desired functions. Although the examples mention rechargeable batteries, non-rechargeable batteries may also apply.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, information indicating a temperature of a battery in a doorbell; and
based on determining that the temperature is below a threshold, forming a pulsed short circuit by periodically connecting a positive electrode of the battery with a negative electrode of the battery.

2. The method of claim 1, further comprising:
ending the pulsed short circuit based on the temperature of the battery exceeding the threshold.

3. The method of claim 1, wherein the forming of the pulsed short circuit is further based on receiving information indicating motion in a proximity of the doorbell.

4. The method of claim 1, wherein the forming of the pulsed short circuit is further based on receiving information indicating motion in a proximity of the doorbell, and the method further comprises:
based on the temperature exceeding the threshold, turning on a camera associated with the doorbell.

5. The method of claim 1, further comprising:
ending the pulsed short circuit based on the temperature of the battery exceeding a charging threshold of the battery.

6. The method of claim 1, further comprising:
ending the pulsed short circuit based on the temperature of the battery exceeding the threshold; and
heating the battery using a second heat source.

7. The method of claim 1, further comprising:
ending the pulsed short circuit based on the temperature of the battery exceeding the threshold;
heating the battery using a power resistor; and
charging the battery after the temperature exceeds a charging threshold of the battery.

8. The method of claim 1, wherein a pulse duration of the pulsed short circuit is based on a fuse connected to the battery.

9. The method of claim 1, wherein an interval of the pulsed short circuit is based on a capacitor associated with the doorbell.

10. The method of claim 1, wherein the information is received via a temperature sensor that is positioned on the negative electrode.

11. A method comprising:
receiving, by a computing device:
information indicating motion in a proximity of a doorbell;
information indicating a temperature of a battery associated with the doorbell;
based on the motion and based on the temperature being below a threshold, activating a heating element associated with the doorbell; and
based on determining that the temperature has risen above the threshold, activating a camera associated with the doorbell.

12. The method of claim 11, wherein the heating element comprises a pulsed short circuit between a positive electrode of the battery and a negative electrode of the battery.

13. The method of claim 11, wherein the heating element comprises a variable power resistor.

14. The method of claim 11, wherein the heating element comprises a pulsed short circuit between a positive electrode of the battery and a negative electrode of the battery, and the method further comprises:
based on the temperature exceeding the threshold, deactivating the heating element.

15. The method of claim 11, wherein the heating element comprises a pulsed short circuit between a positive electrode of the battery and a negative electrode of the battery, and the method further comprises:
based on the temperature exceeding a charging threshold of the battery, deactivating the heating element.

16. The method of claim 11, further comprising transmitting an alert, based on activation of the camera.

17. A method comprising:
activating a battery-operated doorbell camera based on a temperature associated with a battery of the doorbell camera;
receiving video images from the doorbell camera; and
transmit an alert based on the video images.

18. The method of claim 17, wherein the activating the battery-operated doorbell camera is based on the temperature exceeding a threshold.

19. The method of claim 17, wherein the activating the battery-operated doorbell camera is based on heating the battery by a pulsed short circuit that periodically connects a positive electrode of the battery with a negative electrode of the battery.

20. The method of claim 17, further comprising deactivating heating of the battery, based on activation of the battery-operated doorbell camera.
